(19) United States
(12) Patent Application Publication
(10) Pub. No.: US 2008/0178034 A1
(43) Pub. Date: Jul. 24, 2008

(54) REAL-TIME CLOCK APPARATUS, A SEMICONDUCTOR DEVICE, AND AN ELECTRICAL APPARATUS INCLUDING THE REAL-TIME CLOCK APPARATUS

(76) Inventors: Rie Hirayama, Kanagawa (JP); Kazuyuki Tanaka, Tokyo (JP)

Correspondence Address: DICKSTEIN SHAPIRO LLP, 1825 EYE STREET NW, Washington, DC, 20006-5403, US

(21) Appl. No.: 11/854,410

(22) Filed: Sep. 12, 2007

(30) Foreign Application Priority Data
Sep. 26, 2006 (JP) 2006-259969

(51) Int. Cl. G06F 1/14

(52) U.S. Cl. 713/501

(57) ABSTRACT

A real-time clock apparatus, a semiconductor device realizing the real-time clock apparatus, and an electrical apparatus using the real-time clock apparatus are disclosed.

The real-time clock apparatus includes a crystal oscillation circuit, a high-speed timing circuit for dividing an output of the crystal oscillation circuit, a low-speed timing circuit for dividing an output of the high-speed timing circuit, and an interface unit for exchanging a signal with an external apparatus. The crystal oscillation circuit is driven by a first voltage VR1 the high-speed timing circuit is driven by a second voltage VR2, and the low-speed timing circuit and the interface unit are driven by a third voltage VDD, wherein VR1<VR2<VDD. The first voltage VR1 and the second voltage VR2 are generated from the third voltage VDD.

### BACKGROUND OF THE INVENTION

1. Field of the Invention

The present invention relates to a real-time clock generating technique applicable to a mobile terminal, a cellular phone, a digital camera, and an audio apparatus such as a portable type MD (mini disc) apparatus, and various other household electric/electronic appliances; and especially relates to a real-time clock apparatus that includes a crystal oscillation circuit and a dividing circuit that stably operate with low current consumption, a semiconductor device realizing the real-time clock apparatus, and an electrical apparatus using the real-time clock apparatus.

2. Description of the Related Art

It is common practice that an electric/electronic apparatus includes a clock function, and various real-time clock apparatuses have been proposed. For example, Patent Reference 1 discloses a real-time clock apparatus that is capable of generating the same frequency whether driven by a main power supply or driven by a backup power supply that provides a lower voltage than the main power supply.

Without a special device, there is a problem that the frequency is shifted and the accuracy of the clock is degraded when generating a real-time clock using a different power source providing a different voltage. According to Patent Reference 1, the problem is solved by providing a constant voltage circuit so that the same voltage is provided to an oscillation circuit and a dividing circuit whether the power is supplied by the main power supply or the backup power supply.

In addition, Patent References 2 and 3 disclose a technique of reducing current consumption and stabilizing operations, wherein the operating voltage provided to the oscillation circuit is differentiated from the voltage provided to the dividing circuit of the real-time clock.

FIG. 2 shows a configuration example of a conventional real-time clock apparatus that includes a crystal oscillation circuit 21, a dividing circuit (timing circuit) 23, and an interface unit 24.

The real-time clock apparatus is realized by a semiconductor device 20 on a single chip, and further includes a waveform shaping unit 22 for shaping an output of the crystal oscillation circuit into a rectangular waveform. The waveform shaping unit 22 may be a Schmitt trigger circuit, and provides a clock signal to the timing circuit (dividing circuit) 23, which in turn outputs the real-time clock by dividing the clock signal. The interface unit 24 is for exchanging data with an apparatus (e.g., a CPU) external to the real-time clock apparatus.

According to Patent References 1 through 3, the same voltage is provided to the oscillation circuit and the dividing circuit. However, according to the real-time clock apparatus shown in FIG. 2, a voltage VR1a is provided to the crystal oscillation circuit 21, where VR1a is lower than a voltage VDD that is provided to the waveform shaping unit 22, the timing circuit 23, and the interface unit 24. In this way, low current consumption and stable frequency generation are obtained.

Further, with miniaturization of personal electrical apparatuses progressing, the demand for miniaturization of a backup battery is increasing in recent years and continuing. In this connection, the current consumption of the real-time clock apparatus, which continues to work during stand-by periods, is required to be further decreased.

FIG. 3 shows a configuration example of a real-time clock apparatus 30 currently often utilized for reducing the current consumption.

The real-time clock apparatus, which is a single chip semiconductor device 30, includes a crystal oscillation circuit 31, a waveform shaping unit 32 made of, e.g., a Schmitt-trigger circuit for outputting a rectangular clock signal, a high-speed timing circuit 33 for dividing the clock signal, a low-speed timing circuit 34 for further dividing an output of the high-speed timing circuit 33, and an interface unit 35 for exchanging data with circuits (e.g., a CPU) external of the real-time clock apparatus 30.

Here, the combination of the high-speed timing circuit 33 and the low-speed timing circuit 34 is equivalent to the timing circuit 23 in FIG. 2. Then, not only the oscillation circuit 31, but also the waveform shaping unit 32 and the high-speed timing circuit 33 are powered by a constant voltage VR1b that is lower than the main power supply voltage VDD.

[Patent Reference 1] JPA H02-016620

[Patent reference 2] JPA H5-40183

[Patent reference 3] JPA H5-150057

### DISCLOSURE OF INVENTION

### Objective of Invention

However, even if further reduction of the current consumption is attempted by reducing the constant voltage VR1b, the constant voltage cannot be lower than a voltage at which the timing circuit is non-operable (if lowered, the timing circuit does not operate). Further, if a difference between the main power supply voltage VDD and the constant voltage VR1b becomes great, there is a possibility of a level shift becoming difficult. For these reasons, further reduction of the current consumption has been difficult.

### SUMMARY OF THE INVENTION

The present invention provides a real-time clock apparatus, a semiconductor device realizing the real-time clock apparatus, and an electrical apparatus including the real-time clock apparatus that substantially obviate one or more of the problems caused by the limitations and disadvantages of the related art.

Features of embodiments of the present invention are set forth in the description that follows, and in part will become apparent from the description and the accompanying drawings, or may be learned by practice of the invention according to the teachings provided in the description. Problem solutions provided by an embodiment of the present invention may be realized and attained by a real-time clock apparatus, a semiconductor device realizing the real-time clock apparatus, and an electrical apparatus including the real-time clock apparatus particularly pointed out in the specification in such full, clear, concise, and exact terms as to enable a person having ordinary skill in the art to practice the invention.

To achieve these solutions and in accordance with an aspect of the invention, as embodied and broadly described herein, an embodiment of the invention provides a real-time clock apparatus, a semiconductor device realizing the real-time clock apparatus, and an electrical apparatus including the real-time clock apparatus as follows.

### Means for Solving Problems

a) According to an aspect of the embodiment of the present invention, the real-time clock apparatus includes a crystal oscillation circuit, a timing circuit for dividing an output of the crystal oscillation circuit for outputting a real-time clock signal, and an interface unit for exchanging a signal with an external apparatus. Here, the crystal oscillation circuit is driven by a first voltage VR1, at least a part of the timing circuit is driven by a second voltage VR2, and the remainder of the timing circuit and the interface unit are driven by a third voltage VDD, wherein VR1<VR2<VDD.

b) In the real-time clock apparatus according to another aspect of the embodiment, the minimum operating voltage of the crystal oscillation circuit is made lower than the minimum operating voltage of the timing circuit and the interface unit, the first voltage VR1 is slightly greater than but almost the same as the minimum operating voltage of the crystal oscillation circuit, and the first voltage VR1 is lower than the minimum operating voltage of the timing circuit and the interface unit.

c) In the real-time clock apparatus according to another aspect of the embodiment, the first voltage VR1 and the second voltage VR2 are constant voltages.

d) According to another aspect of the embodiment, the constant voltages VR1 and VR2 are generated by voltage regulators, to which the third voltage VDD is supplied. The constant voltages VR1 and VR2 may be simultaneously generated in parallel by the voltage regulators. Alternatively, VR1 is first generated by a first voltage regulator to which VDD is supplied, and then VR2 is generated by a second voltage regulator to which VR1 is supplied. Further alternatively, VR2 may be first generated by the first voltage regulator to which VDD is supplied, and then VR1 may be generated by the second voltage regulator to which VR2 is supplied.

e) Another aspect of the embodiment provides a semiconductor device that includes the real-time clock apparatus as described above in one single chip. Another aspect of the embodiment provides an electrical apparatus that includes one of the real-time clock apparatus and the semiconductor device. Examples of the electrical apparatus include a mobile terminal, a cellular phone, a video apparatus, an audio apparatus, and a home electronics appliance.

### Effectiveness of Invention

Effectiveness of the present invention is as follows.

a) Current consumption of each of the crystal oscillation circuit, the waveform shaping unit, and the timing circuit can be reduced.

b) The current consumption of the crystal oscillation circuit can be minimized.

c) The current consumption and oscillating frequency of the crystal oscillation circuit, and the current consumption of the waveform shaping unit and the timing circuit are made independent of the power supply voltage.

d) The real-time clock that requires the least current consumption without power-supply-voltage dependence can be driven by one external power supply.

e) The semiconductor device and the electrical apparatus that enjoy the above-described advantages are realized.

### BRIEF DESCRIPTION OF THE DRAWINGS

FIG. 1 is a block diagram of a semiconductor device 10 according to an embodiment of the present invention;

FIG. 2 is a block diagram of a general-practice example of a real-time clock apparatus that includes a crystal oscillation circuit, a dividing circuit (timing circuit), and an interface unit;

FIG. 3 is a block diagram of a real-time clock apparatus used in general practice in order to reduce current consumption; and

FIG. 4 is a block diagram showing details of a high-speed dividing circuit and a low-speed dividing circuit shown in FIG. 1.

### DESCRIPTION OF THE PREFERRED EMBODIMENTS

In the following, embodiments of the present invention are described with reference to the accompanying drawings.

### Outline of the Present Invention

In a real-time clock, a crystal oscillation circuit usually consumes the greatest current. Accordingly, in order to reduce the current consumption of the real-time clock, reducing the current consumption of the crystal oscillation circuit with a lower operating voltage is important.

Then, according to the present invention, the minimum operating voltage of the oscillation circuit is designed to be lower than that of other circuits. Specifically, the crystal oscillation circuit is driven by a first voltage VR1, a waveform shaping unit and a high-speed timing circuit are driven by a second voltage VR2, and a low-speed timing circuit and an interface unit are driven by a third voltage VDD. Here, VR1<VR2<VDD. In this way, the crystal oscillation circuit is driven by the first voltage VR1 that is lower than the other voltages. In this way, the voltages supplied to the circuits can be near the corresponding minimum operating voltages, which reduce the current consumption; further a difficulty of a level shift is avoided by making the driving voltages in three levels.

### Embodiment

The embodiment of the present invention is described with reference to the attached drawings.

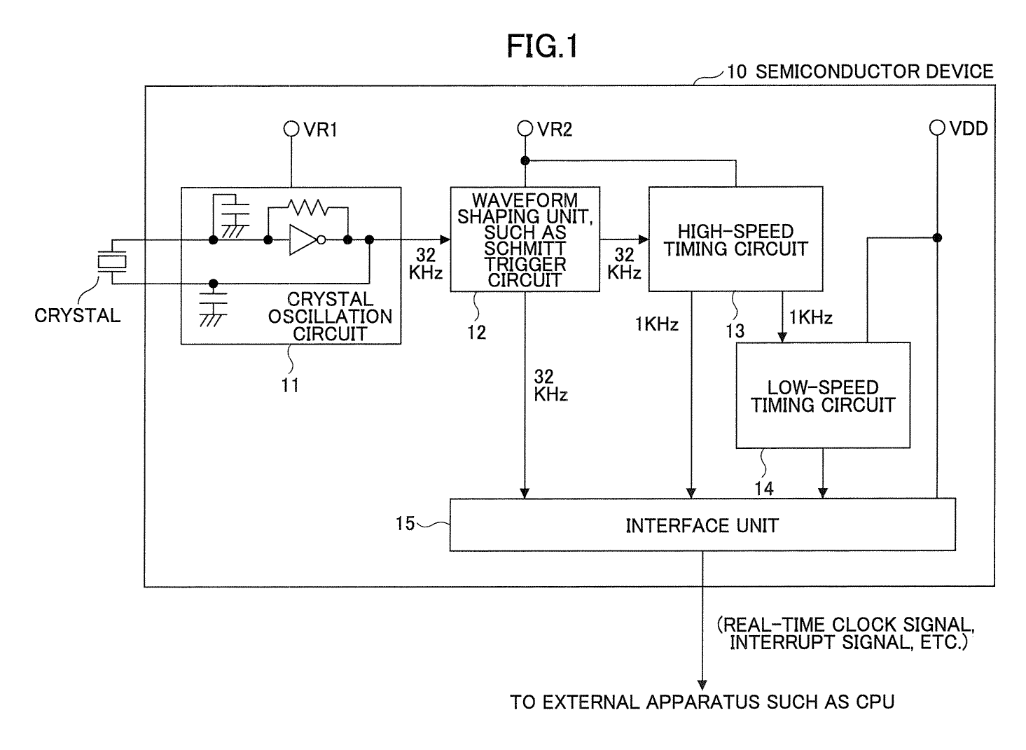

FIG. 1 is a block diagram of a real-time clock apparatus that is realized by a semiconductor device 10 according to the embodiment of the present invention.

The semiconductor device 10 is a single chip device that serves as the real-time clock apparatus of the embodiment of the present invention, and includes a crystal oscillation circuit 11, a waveform shaping unit 12 such as a Schmitt trigger circuit for shaping the waveform of a signal provided by the crystal oscillation circuit 11 into a rectangular waveform, a high-speed timing circuit 13 for dividing a signal provided by the waveform shaping unit 12, a low-speed timing circuit 14 for further dividing a signal provided by the high-speed timing circuit 13, and an interface unit 15 for exchanging data with circuits outside of the real-time clock apparatus.

The crystal oscillation circuit 11 is designed so that its minimum operating voltage is lower than the other circuits. The voltage VR1 provided to the crystal oscillation circuit 11 is a constant voltage lowered to near the minimum operating voltage of the crystal oscillation circuit 11. The voltage VR2 provided to the waveform shaping unit 12 and the high-speed timing circuit 13 is greater than their minimum operating voltages, and is less than VDD, which is the main power supply voltage provided to the low-speed timing circuit 14 and the interface unit 15.

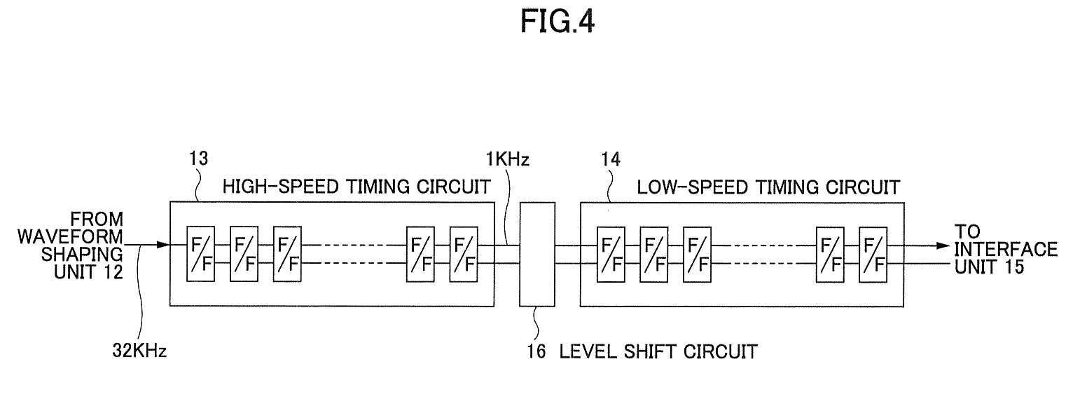

FIG. 4 is a block diagram showing configuration details of the high-speed dividing (timing) circuit 13 and the low-speed dividing (timing) circuit 14 shown in FIG. 1. The configuration includes flip-flops (F/F) that are tandem-connected (cascaded). The high-speed timing circuit 13 divides a 32 kHz signal provided by the waveform shaping unit 12 for generating a 1 kHz clock signal. The low-speed timing circuit 14 divides the 1 kHz signal from the high-speed dividing circuit 13 for generating a real-time clock, and provides the real-time clock to the interface unit 15. In addition, a level shift circuit 16 is provided between the high-speed timing circuit 13 and the low-speed timing circuit 14. Since the constant voltage VR2 is between the constant voltage VR1 and the main power supply voltage VDD, the level difference of the voltages is small, and the level shift circuit 16 can be easily configured.

By providing three different voltages in the real-time clock apparatus, and by making the minimum operating voltage of the crystal oscillation circuit 11 lower than other circuits (e.g., the waveform shaping unit 12, the high-speed timing circuit 13, and the low-speed timing circuit 14), a voltage that cannot drive the other circuits is used to operate the crystal oscillation circuit 11. By providing the constant voltage VR1 that is near the minimum voltage for driving the crystal oscillation circuit 11, the current consumption of the crystal oscillation circuit 11, which consumes the greatest current within the real-time clock apparatus, can be reduced.

Further, by making the constant voltage VR2 between the VR1 and VDD, the current consumption of the waveform shaping unit 12 and the high-speed timing circuit 13 is reduced; in addition, the level shift of the voltage is facilitated.

According to the embodiment as described above, the current consumption of the crystal oscillation circuit 11, the waveform shaping unit 12, and the high-speed timing circuit 13 is remarkably reduced compared with the conventional real-time clock apparatus. Further, since the voltages are regulated, operations of the real-time clock apparatus of the embodiment are stable without dependence on the external power supply voltage.

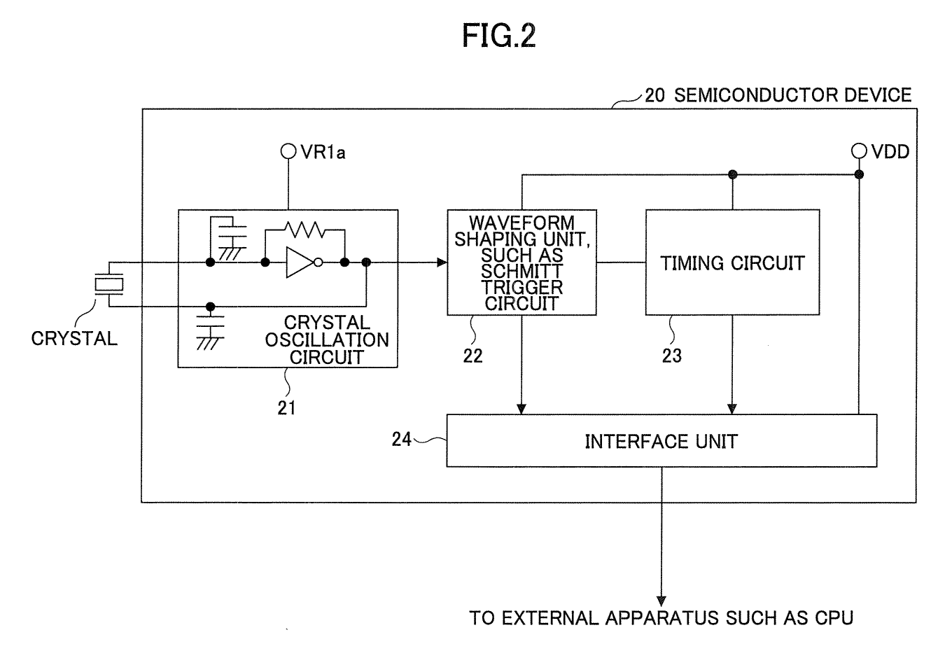

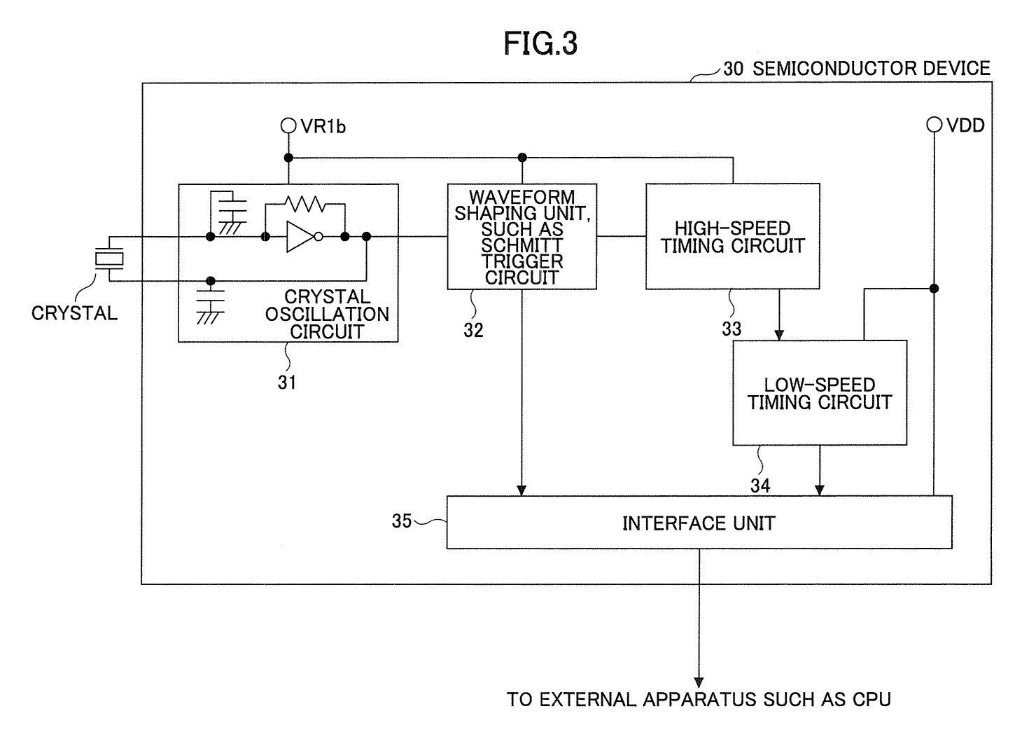

Next, an example of the current consumption in the case of the embodiment of the present invention as shown in FIG. 1 is compared with conventional examples shown in FIGS. 2 and 3 to ascertain the reduced current consumption of the embodiment.

With the real-time clock apparatus shown in FIG. 2, when the constant voltage VR1a is between 1.1 V and 1.5 V, and the constant voltage VDD is 5.5 V, the current consumption is about 0.5 μA. In the case of the real-time clock apparatus shown in FIG. 3, the constant voltage VDD is 5.5 V, which is the same as FIG. 2; however the constant voltage VR1b has to be higher than in FIG. 1 because this voltage is to operate the timing circuit, and is between 1.3 V and 1.5 V. Here, the current consumption is about 0.4 μA.

According to the real-time clock apparatus of the embodiment shown in FIG. 1, the constant voltage VDD is 5.5 V (although between 3 V and 5 V is sufficient), the constant voltage VR2 for the high-speed timing circuit 13 is in the same range between 1.3 V and 1.5 V as the VR1b in FIG. 3 (this is because the high-speed timing circuits 13, 33 require the same voltage). However, due to the crystal oscillation circuit 11 that requires a minimum operating voltage that is lower than before, the constant voltage VR1 can be as low as between 0.9 V and 1.2 V. In this way, the current consumption is reduced to a range between 0.25 μA and 0.3 μA.

Further, by providing the constant voltage VR2 between the constant voltage VR1 and the constant voltage VDD, the level shift between the circuits can be made small.

Here, the constant voltage VR1 and the constant voltage VR2 used in the embodiment can be generated by voltage regulators. Accordingly, only one power supply for VDD is required from outside by the real-time clock apparatus. The constant voltages VR1 and VR2 may be simultaneously generated in parallel from the constant voltage VDD with the voltage regulators. Alternatively, the constant voltage VR2 may be first generated by a first voltage regulator from the constant voltage VDD, and then, the constant voltage VR1 is generated by a second voltage regulator from the constant voltage VR2. Here, the sequence of generating the constant voltage VR1 and the constant voltage VR2 may be reversed.

According to the embodiment of the present invention described above, the real-time clock apparatus that requires remarkably less current consumption is realized, wherein dependency on the main power-supply-voltage supplied from the outside is reduced.

The real-time clock apparatus according to the embodiment of the present invention can be integrated in a single semiconductor chip, and included in various electric/electronic apparatuses such as a mobile terminal, a cellular phone, a digital camera, and a portable type MD (mini disc) apparatus; and various household-electric-appliances such as audio apparatuses, rice cookers, and air-conditioners.

Further, the present invention is not limited to these embodiments, but variations and modifications may be made without departing from the scope of the present invention.

The present application is based on Japanese Priority Application No. 2006-259969 filed on Sep. 26, 2006 with the Japanese Patent Office, the entire contents of which are hereby incorporated by reference.

What is claimed is:

1. A real-time clock apparatus comprising:
a crystal oscillation circuit;
a timing circuit for dividing an output of the crystal oscillation circuit, and for outputting a real-time clock signal; and
an interface unit for exchanging a signal with an external apparatus; wherein
the crystal oscillation circuit is driven by a first voltage VR1, at least a part of the timing circuit is driven by a second voltage VR2, and the remainder of the timing circuit and the interface unit are driven by a third voltage VDD, where the first voltage VR1<the second voltage VR2<the third voltage VDD.

2. The real-time clock apparatus as claimed in claim 1, wherein
a minimum operating voltage of the crystal oscillation circuit is lower than a minimum operating voltage of the timing circuit and the interface unit, and
the first voltage VR1 is nearly equal to and greater than the minimum operating voltage of the crystal oscillation circuit, and less than the minimum operating voltage of the timing circuit and the interface unit.

3. The real-time clock apparatus as claimed in claim 1, wherein
the first voltage VR1 and the second voltage VR2 are constant voltages.

4. The real-time clock apparatus as claimed in claim 3, wherein
the first voltage VR1 and the second voltage VR2 are generated by voltage regulators that are powered by the third voltage VDD.

5. The real-time clock apparatus as claimed in claim 4, wherein
the first voltage VR1 and the second voltage VR2 are generated by one of the following circuit configurations,
the voltages VR1 and VR2 are generated by voltage regulators in parallel, to which voltage regulators the third voltage VDD is supplied,
the first voltage VR1 is generated by a first voltage regulator, to which first voltage regulator the third voltage VDD is supplied, and the second voltage VR2 is generated by a second voltage regulator, to which second voltage regulator the first voltage VR1 is supplied, and
the second voltage VR2 is generated by the first voltage regulator, to which first voltage regulator the third voltage VDD is supplied, and the first voltage VR1 is generated by the second voltage regulator, to which second voltage regulator the second voltage VR2 is supplied.

6. A semiconductor device, comprising the real-time clock apparatus as claimed in claim 1 in one chip.

7. An electrical apparatus, comprising one of the real-time clock apparatus as claimed in claim 1 and the semiconductor device as claimed in claim 6.

8. The electrical apparatus as claimed in claim 7, wherein the electrical apparatus is one of a mobile terminal unit, a cellular phone, a video apparatus, an audio apparatus, and a home appliance.
